(19) United States
(12) Patent Application Publication
(10) Pub. No.: US 2011/0260997 A1
(43) Pub. Date: Oct. 27, 2011

(54) INFORMATION PROCESSING APPARATUS AND DRAG CONTROL METHOD

(75) Inventor: Takahiro Ozaki, Tokyo (JP)

(73) Assignee: KABUSHIKI KAISHA TOSHIBA, Tokyo (JP)

(21) Appl. No.: 13/081,894

(22) Filed: Apr. 7, 2011

(30) Foreign Application Priority Data
Apr. 22, 2010 (JP) 2010-098961

(51) Int. Cl. G06F 3/041

(52) U.S. Cl. 345/173

(57) ABSTRACT

According to one embodiment, an information processing apparatus includes a first touch-screen display, a second touch-screen display, a first movement control module and a second movement control module. The first movement control module selects an object on the first touch-screen display in accordance with a touch position on the first touch-screen display, and moves a position of the selected object in accordance with a movement of the touch position on the first touch-screen display. The second movement control module moves the position of the selected object from the first touch-screen display to the second touch-screen display in order to display the selected object on the second touch-screen display when the selected object is moved to an end part on the first touch-screen display. The end part on the first touch-screen display is opposed to a boundary between the first touch-screen display and the second touch-screen display.

### CROSS-REFERENCE TO RELATED APPLICATIONS

This application is based upon and claims the benefit of priority from Japanese Patent Application No. 2010-098961, filed Apr. 22, 2010, the entire contents of which are incorporated herein by reference.

### FIELD

Embodiments described herein relate generally to an information processing apparatus comprising a touch-screen display.

### BACKGROUND

In recent years, various types of portable personal computers have been developed. Modern personal computers employ a user interface using a touch-screen display, thereby realizing a more intuitive operation. In the computer with the touch-screen display, a user can perform a drag operation of moving a display object on a screen (e.g. an icon, a window, etc.) within the screen, for example, by moving a fingertip while keeping the fingertip in contact with the object.

Recently, a system using a plurality of touch-screen displays has begun to be developed.

However, when a plurality of touch-screen displays are used, it is difficult to move an object on the screen of a certain touch-screen display to the screen of another touch-screen display. The reason is that since the touch-screen displays are physically separated in usual cases, the movement of the fingertip is discontinued by the space between the touch-screen displays and it is difficult to continuously move the fingertip across the touch-screen displays.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating the external appearance of an information processing apparatus according to an embodiment.

FIG. 2 illustrates an example of the mode of use of the information processing apparatus of the embodiment.

FIG. 3 illustrates another example of the mode of use of the information processing apparatus of the embodiment.

FIG. 4 is an exemplary block diagram illustrating the system configuration of the information processing apparatus of the embodiment.

FIG. 5 is an exemplary block diagram illustrating a structure example of a drag control program which is used in the information processing apparatus of the embodiment.

FIG. 6 illustrates an example of a drag control process which is executed by the information processing apparatus of the embodiment.

FIG. 7 illustrates another example of the drag control process which is executed by the information processing apparatus of the embodiment.

FIG. 8 illustrates still another example of the drag control process which is executed by the information processing apparatus of the embodiment.

FIG. 9 illustrates still another example of the drag control process which is executed by the information processing apparatus of the embodiment.

FIG. 10 illustrates still another example of the drag control process which is executed by the information processing apparatus of the embodiment.

FIG. 11 illustrates still another example of the drag control process which is executed by the information processing apparatus of the embodiment.

FIG. 12 illustrates still another example of the drag control process which is executed by the information processing apparatus of the embodiment.

FIG. 13 is an exemplary flow chart illustrating an example of the procedure of the drag control process which is executed by the information processing apparatus of the embodiment.

### DETAILED DESCRIPTION

Various embodiments will be described hereinafter with reference to the accompanying drawings.

In general, according to one embodiment, an information processing apparatus comprises a first touch-screen display, a second touch-screen display, a first movement control module and a second movement control module. The first movement control module is configured to select an object on the first touch-screen display in accordance with a touch position on the first touch-screen display, and to move a position of the selected object in accordance with a movement of the touch position on the first touch-screen display. The second movement control module is configured to move the position of the selected object from the first touch-screen display to the second touch-screen display in order to display the selected object on the second touch-screen display when the selected object is moved to an end part on the first touch-screen display. The end part on the first touch-screen display is opposed to a boundary between the first touch-screen display and the second touch-screen display.

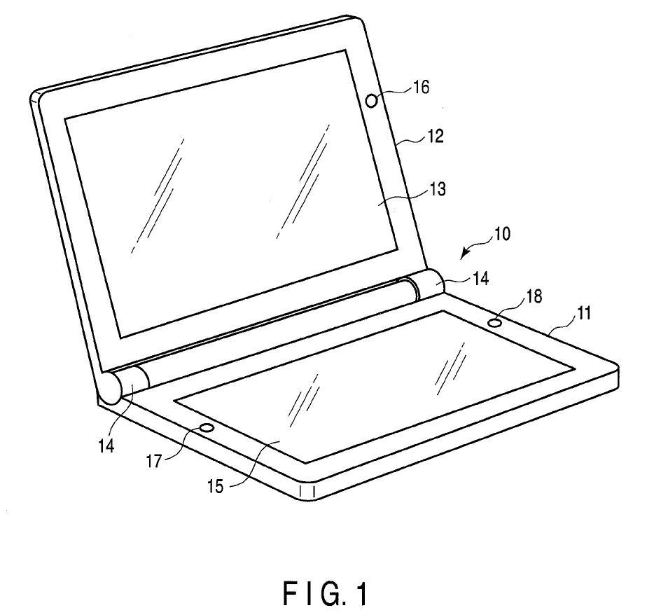

To begin with, referring to FIG. 1, an information processing apparatus according to an embodiment is described. This information processing apparatus is realized, for example, as a battery-powerable portable personal computer 10.

FIG. 1 is a perspective view showing the personal computer 10 in a state in which a display unit of the personal computer 10 is opened. The computer 10 comprises a computer main body 11 and a display unit 12. A display device comprising a liquid crystal display (LCD) 13 is built in a top surface of the display unit 12, and a display screen of the LCD 13 is disposed at a substantially central part of the display unit 12.

The LCD 13 is realized as a touch-screen display. The touch-screen display is configured to detect a position (touch position) on a screen of the LCD 13, which is touched by a pen or a finger. The touch-screen display is also referred to as a “touch-sensitive display”. For example, a transparent touch panel may be disposed on the top surface of the LCD 13. The above-described touch-screen display is realized by the LCD 13 and the transparent touch panel. The user can select various objects, which are displayed on the display screen of the LCD 13 (e.g. icons representing folders and files, menus, buttons and windows) by using a fingertip or a pen. The coordinate data representing a touch position on the display screen is input from the touch-screen display to the CPU in the computer 10.

The display unit 12 has a thin box-shaped housing. The display unit 12 is rotatably attached to the computer main body 11 via a hinge portion 14. The hinge portion 14 is a coupling portion for coupling the display unit 12 to the computer main body 11. Specifically, a lower end portion of the display unit 12 is supported on a rear end portion of the computer main body 11 by the hinge portion 14. The display unit 12 is attached to the computer main body 11 such that the display unit 12 is rotatable, relative to the computer main body 11, between an open position where the top surface of the computer main body 11 is exposed and a closed position where the top surface of the computer main body 11 is covered by the display unit 12. A power button 16 for powering on or off the computer 10 is provided at a predetermined position on the top surface of the display unit 12, for example, on the right side of the LCD 13.

The computer main body 11 is a base unit having a thin box-shaped housing. A liquid crystal display (LCD) 15 is built in a top surface of the computer main body 11. A display screen of the LCD 15 is disposed at a substantially central part of the computer main body 11. The LCD 15 is also realized as a touch-screen display (i.e. touch-sensitive display). The touch-screen display is configured to detect a position (touch position) on the screen of the LCD 15, which is touched by a pen or a finger. A transparent touch panel may be disposed on the upper surface of the LCD 15. The above-described touch-screen display is realized by the LCD 15 and the transparent touch panel.

The LCD 15 on the computer main body 11 is a display which is independent from the LCD 13 of the display unit 12. The LCDs 13 and 15 can be used as a multi-display for realizing a virtual screen environment. In this case, two virtual screens, which are managed by the operating system of the computer 10, may be allocated to the LCDs 13 and 15, respectively, or a single virtual screen, which is managed by the operating system of the computer 10, may be allocated to the LCDs 13 and 15. In the latter case, the single virtual screen includes a first screen region, which is displayed on the LCD 13, and a second screen region, which is displayed on the LCD 15. The first screen region and the second screen region are allocated to the LCDs 13 and 15, respectively. Each of the first screen region and the second screen region can display an arbitrary application window, an arbitrary object, etc.

The two LCDs 13 and 15 are physically spaced apart by the hinge portion 14. In other words, the surfaces of the two touch-screen displays are discontinuous, and these two discontinuous touch-screen displays constitute a single virtual screen.

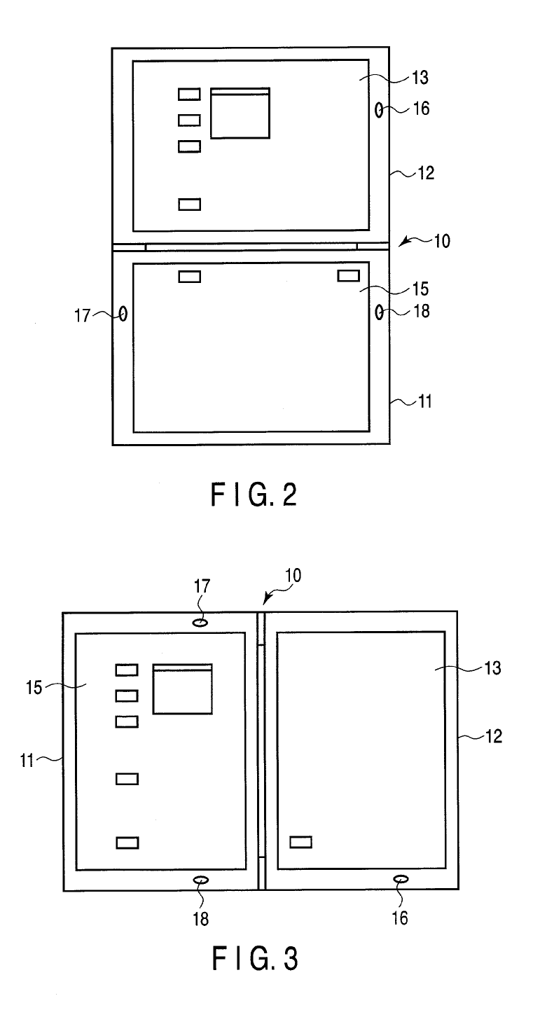

In the present embodiment, the computer 10 can be used in a horizontal position (landscape mode) shown in FIG. 2 and in a vertical position (portrait mode) shown in FIG. 3. In the landscape mode, two touch-screen displays in a single virtual screen are used in the state in which the touch-screen displays are arranged in the up-and-down direction. On the other hand, in the portrait mode, the two touch-screen displays in the single virtual screen are used in the state in which the touch-screen displays are arranged in the right-and-left direction. The direction of screen images displayed on the respective touch-screen displays are automatically changed according to the mode used (landscape mode, portrait mode).

As shown in FIG. 1, two button switches 17 and 18 are provided at predetermined positions on the upper surface of the computer main body 11, for example, on both sides of the LCD 15. Arbitrary functions can be assigned to the button switches 17 and 18. For example, the button switch 17 may be used as a button switch for displaying a virtual keyboard on the LCD 13 or LCD 15.

In the above description, the case has been assumed in which the computer 10 includes two spaced-apart, discontinuous touch-screen displays. Alternatively, the computer 10 may include three or four mutually spaced-apart, discontinuous touch-screen displays.

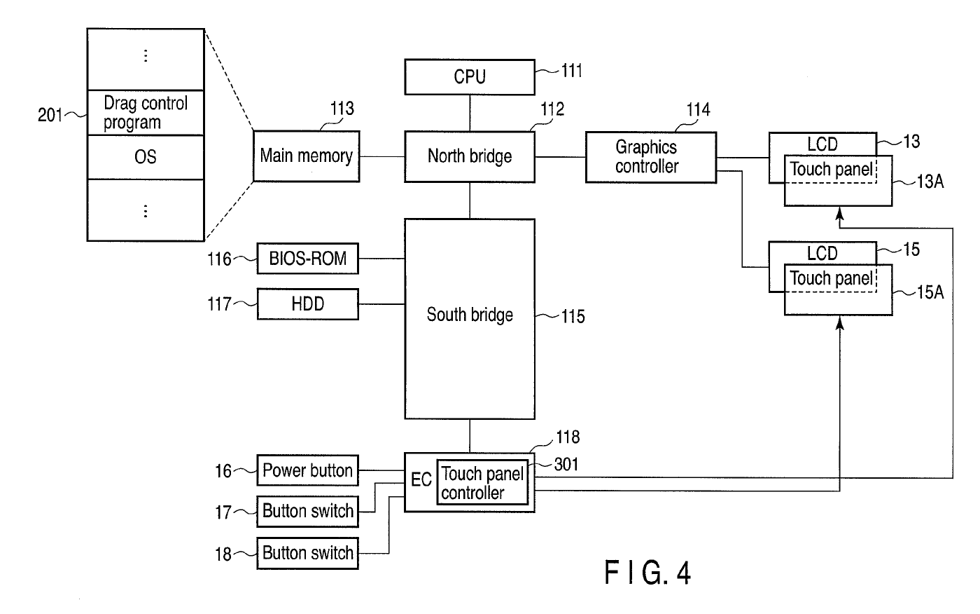

Next, referring to FIG. 4, the system configuration of the computer 10 is described. The case is now assumed in which the computer 10 includes two touch-screen displays.

The computer 10 comprises a CPU 111, a north bridge 112, a main memory 113, a graphics controller 114, a south bridge 115, a BIOS-ROM 116, a hard disk drive (HDD) 117, and an embedded controller 118.

The CPU 111 is a processor which is provided in order to control the operation of the computer 10. The CPU 111 executes an operating system (OS) and various application programs, which are loaded from the HDD 117 into the main memory 113.

The application programs include a drag control program 201. The drag control program 201 executes a process for dragging a display object (also referred to simply as “object”) across a source touch-screen display (a touch-screen display at a source of movement) and a target touch-screen display (a touch-screen display at a destination of movement), which are discontinuous. To be more specific, when a certain touch-screen display (source touch screen-display) is touched, the drag control program 201 selects an object on the source touch-screen display in accordance with the touch position. The drag control program 201 moves the position of the selected object on the source touch-screen display in accordance with the movement of the touch position (the movement of the fingertip) on the source touch-screen display. When the selected object has been moved to an end part on the source touch-screen display, the drag control program 201 determines a target touch screen display. In this case, another touch-screen display, which has an end part opposed to the end part of the source touch-screen display via a display boundary, is determined to be the target touch-screen display. In order to display the selected object on the target touch-screen display, the drag control program 201 moves (skips) the position of the selected object from the source touch-screen display to the target touch-screen display. In this case, the selected object may be moved from the end part of the source touch-screen display to, for example, the end part of the target touch-screen display which is opposed to the display boundary.

Although the operation of movement of the fingertip is interrupted at the end of the source display, that is, immediately before the display boundary, the object can easily be moved across the source display and the target display which are discontinuous. After the object is moved to the target touch-screen display, the user can continuously execute the drag operation of the object on the target display.

In order to realize the above-described drag control process, the drag control program 201 includes, for example, the following functions.

(1) A function of detecting a drag of a display object with use of a touch operation and moving the display object.

(2) A function of detecting an approach of the display object to the display boundary by a drag.

(3) A function of determining a target display (this determining function enables a drag operation across more than two displays).

(4) A function of moving the position of the selected object toward the target touch-panel screen by a predetermined distance.

(5) A function of determining a position at which the display object is to be displayed on the target display, from the locus of movement of the display object.

Besides, the CPU 111 executes a system BIOS (Basic Input/Output System) which is stored in the BIOS-ROM 116. The system BIOS is a program for hardware control. The north bridge 112 is a bridge device which connects a local bus of the CPU 111 and the south bridge 115. The north bridge 112 comprises a memory controller which access-controls the main memory 113. The graphics controller 114 is a display controller which controls the two LCDs 13 and 15 which are used as a display monitor of the computer 10. The graphics controller 114 executes a display process (graphics arithmetic process) for rendering display data on a video memory (VRAM), based on a rendering request which is received from the CPU 111 via the north bridge 112. A memory area for storing display data corresponding to a screen image which is displayed on the LCD 13 and a memory area for storing display data corresponding to a screen image which is displayed on the LCD 15 are allocated to the video memory.

A transparent touch panel 13A is disposed on the LCD 13. The LCD 13 and the touch panel 13A constitute a first touch-screen display. Similarly, a transparent touch panel 15A is disposed on the LCD 15. The LCD 15 and the touch panel 15A constitute a second touch-screen display. Each of the touch panels 13A and 15B is configured to detect a touch position on the touch panel (touch-screen display) by using, for example, a resistive method or a capacitive method. As each of the touch panel 13A and 15A, use may be made of a multi-touch panel which can detect a plurality of touch positions at the same time.

The south bridge 115 incorporates an IDE (Integrated Drive Electronics) controller and a Serial ATA controller for controlling the HDD 121. The embedded controller (EC) 118 has a function of powering on/off the computer 10 in accordance with the operation of the power button switch 16 by the user. In addition, the embedded controller (EC) 118 comprises a touch panel controller 301 which controls each of the touch panels 13A and 15B.

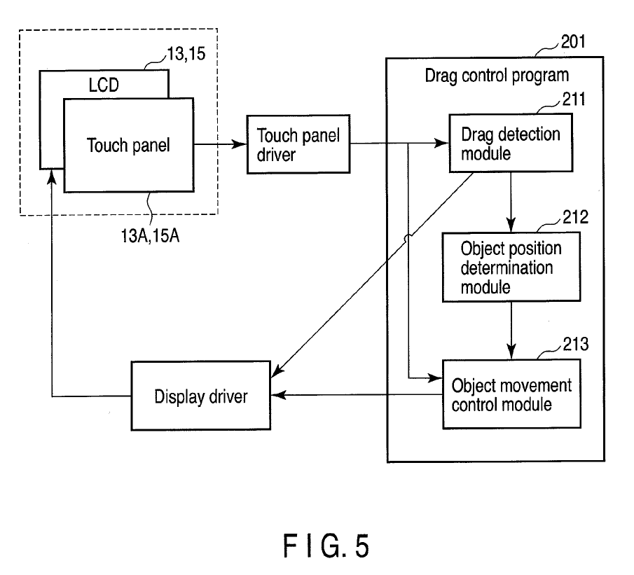

Next, referring to FIG. 5, the functional structure of the drag control program 201 is described.

The drag control program 201 receives touch position detection information from each of the touch panels 13A and 15A via a touch panel driver program in the operating system. The touch position detection information includes coordinate data indicative of a touch position on the touch panel display, which is touched by a pointing member (e.g. the user's fingertip, or a pen).

The drag control program 201 includes, as function-executing modules, a drag detection module 211, an object position determination module 212 and an object movement control module 213. The drag detection module 211 functions as a first movement control module for detecting a drag of a display object by a touch operation and moving the display object.

The drag detection module 211 selects an object on a touch-screen display (LCD 13 or LCD 15) in accordance with a touch position on the touch-screen display. For example, an object displayed at a touch position is selected from among objects displayed on the touch-screen display. The drag detection module 211 moves, via a display driver program, the position of the selected object on the touch-screen display. In this case, the drag detection module 211 moves the position of the selected object on the touch-screen display in accordance with the movement of the touch position on the touch-screen display. The movement of the touch position, in this context, means a drag operation. The drag operation is an operation of moving a position (touch position) on the touch-screen display, which is touched by the pointing member (fingertip or pen), in the state in which the pointing member is in contact with the touch-screen display. On the touch-screen display, the position of the object is moved in a manner to follow the movement of the touch position.

The object position determination module 212 determines whether the object has been moved to an end part on the touch-screen display, for example, an end part adjoining the border between the displays. The object movement control module 213 functions as a second movement control module for moving, via the display driver, the position of the object on the touch-screen display (LCD 13 or LCD 15). To be more specific, if the object position determination module 212 determines that the object has been moved to the end part on the touch screen display, the object movement control module 213 determines a target touch screen display. Then, the object movement control module 213 moves (skips) the position of the object to an end part of the target touch-screen display, which adjoins the boundary between the displays. To be more specific, the object movement control module 213 moves the position of the object toward the target touch-screen display by a predetermined distance. Although the distance of movement may be a fixed value, the distance of movement may be set at, e.g. a distance which is associated with the size of the object, etc.

The object is displayed, for example, at an end part of the target touch-screen display. In the present embodiment, as described above, when it is detected that the object has been moved to the end part of the source touch-screen display by the drag using the touch operation, the position of the object is automatically changed from the source touch-screen display to the target touch-screen display.

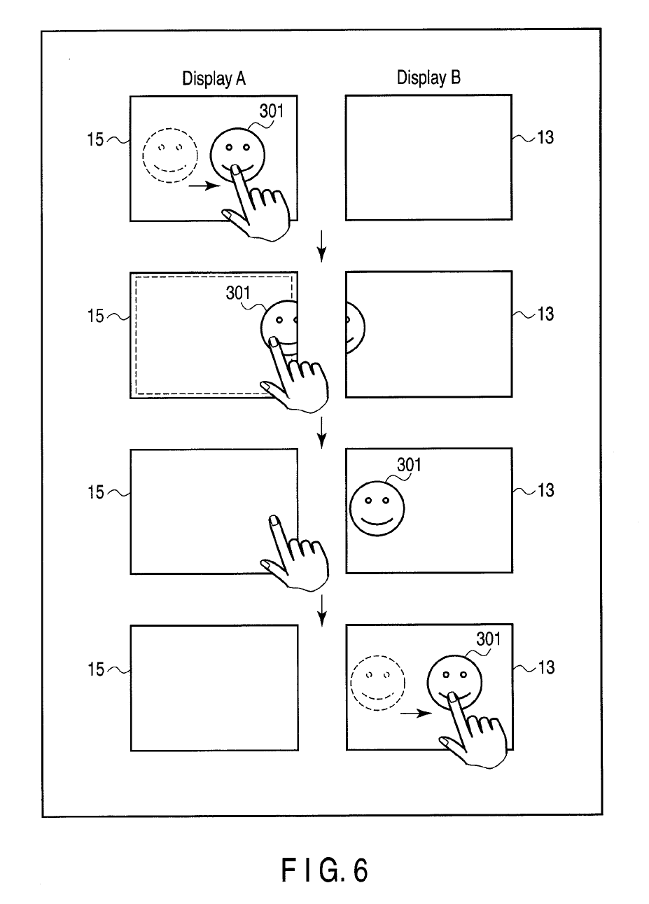

Next, referring to FIG. 6, a description is given of an example of a drag control operation for dragging an object across touch-screen displays, which is executed by the drag control program 201. In FIG. 6, a “display A” represents a source touch-screen display, and a “display B” represents a target touch-screen display. The case is assumed in which the touch-screen display 15 is the source touch-screen display, and the touch-screen display 13 is the target touch-screen display.

An uppermost part of FIG. 6 shows a state in which an object 301, which is displayed on the source touch-screen display, is touched by the fingertip, and the object 301 is dragged. In the state in which the user's fingertip is put in contact with the source touch-screen display, the user moves the fingertip, i.e. the touch position, whereby the user can move the position of the object 301.

A second part from above in FIG. 6 shows a state in which the object 301 has been moved to an end part of the source touch-screen display by a drag operation. A broken line on the source touch-screen display represents a boundary position for determining an end part of the source touch-screen display. The boundary position may be set at, for example, a position which is located inside the end of the source touch-screen display by a short distance (e.g. about several mm). For example, when an approximately central part of the object 301 overlaps the boundary position, a certain part of the object 301 protrudes outward from the source touch-screen display, and becomes invisible. At this time, the drag control program 201 determines that the object 301 has been moved to the end part of the source touch-screen display. In other words, when the ratio of that part of the object 301, which is displayed on the source touch-screen display, to the entirety of the object 301 has decreased to a predetermined threshold ratio which is less than 100%, the drag control program 201 may determine that the object 301 has been moved to the end part of the source touch-screen display.

If the source touch-screen display and the target touch-screen display constitute a single virtual screen, the part (invisible part) of the object 301, which disappears from the source touch-screen display, may be displayed on the target touch-screen display. In this case, however, if the size of the object 301 is small, the part of the object 301, which protrudes from the source touch-screen display, is very small. Thus, only the small part of the object 301 is displayed on the target touch-screen display. There is a possibility that it is very difficult for the user to touch this small part on the target touch-screen display.

When the object 301 has been moved to the end part of the source touch-screen display, the drag control program 201, as shown in a third part from above in FIG. 6, moves the position of the object 301 from the end part on the source touch-screen display to the neighborhood of the end part of the target touch-screen display, so that, for example, almost the entirety of the object 301 is displayed on the neighborhood of the end part of the target touch-screen display. Thereby, for example, almost the entirety of the object 301 is displayed on the target touch-screen display.

A lowermost part of FIG. 6 illustrates a state in which the object 301, which has been moved onto the target touch-screen display, is touched by the fingertip once again, and the object 301 is dragged on the target touch-screen display. In the state in which the user puts the fingertip in contact with the target touch-screen display, the user moves the fingertip, that is, the touch position. Thereby, the position of the object 301 can be moved (dragged).

The drag control program 201 may continue the drag of the object 301, only when the object 301 is touched during a predetermined period from a time point when the position of the object 301 is moved from the source touch-screen display to the target touch-screen display. In this case, if the object 301 on the target touch-screen display is not touched during the predetermined period (time-out), the drag control program 201 executes, for example, the following process of mode 1 or mode 2.

Mode 1: The drag control program 201 returns the object 301 to the region of the end part of the source touch-screen display (the object 301 is returned to the state shown in the second part from above in FIG. 6).

Mode 2: The drag control program 201 leaves the object 301 on the region of the end part on the target touch-screen display (the object 301 is kept in the state shown in the third part from above in FIG. 6).

The drag control program 201 includes a user interface which enables the user to select mode 1 or mode 2. Using this user interface displayed by the drag control program 201, the user can designate in advance the operation which is to be executed at the time of time-out.

FIG. 6 illustrates the example in which the object 301 is moved in such a manner that the entirety of the object 301 is displayed on the target touch-screen display. However, the embodiment is not limited to this example, and the object 301 may be moved, for example, in such a manner that a part of the object 301 is displayed on the target touch-screen display. Also in this case, the drag control program 201 moves the object 301 toward the target touch-screen display by a predetermined distance, so that the size of the part of the moved object 301, which is displayed on the target touch-screen display, may become greater than the size of the part of the object 301 which protrudes from the source touch-screen display before the movement.

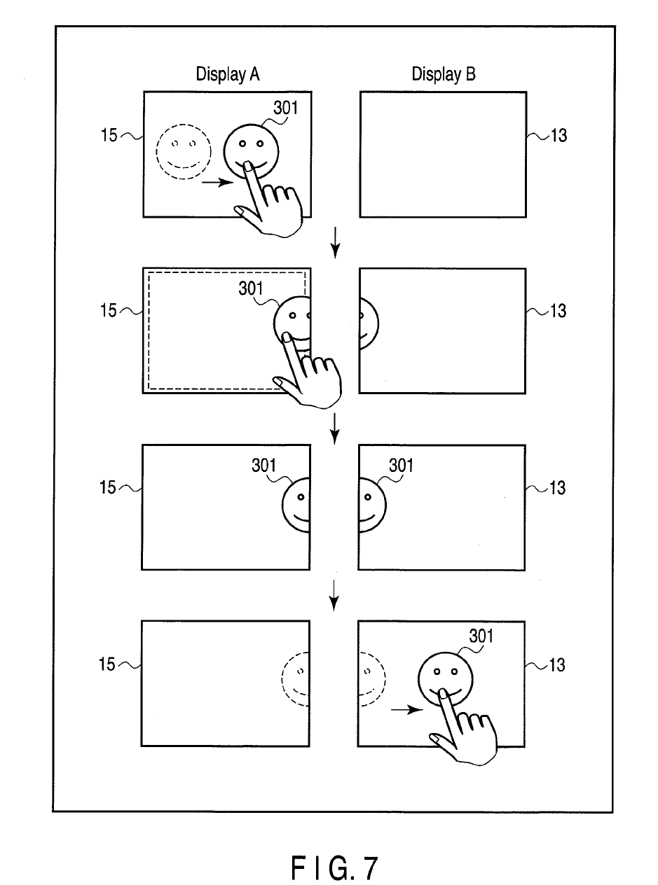

FIG. 7 illustrates an example in which the amount of movement of the object 301 is controlled in such a manner that the ratio between the part of the object 301, which is displayed on the source touch-screen display, and the part of the object 301, which is displayed on the target touch-screen display, is a fixed ratio (e.g. 50:50).

An uppermost part of FIG. 7 shows a state in which the object 301, which is displayed on the source touch-screen display, is touched by the fingertip, and the object 301 is dragged.

A second part from above in FIG. 7 shows a state in which the object 301 has been moved to an end part of the source touch-screen display by a drag operation. When the ratio of that part of the object 301, which is displayed on the source touch-screen display, to the entirety of the object 301 has decreased to a predetermined threshold ratio which is less than 100%, the drag control program 201 determines that the object 301 has been moved to the end part of the source touch-screen display.

When the object 301 has been moved to the end part of the source touch-screen display, the drag control program 201, as shown in a third part from above in FIG. 7, moves the position of the object 301 from the source touch-screen display toward the target touch-screen display, so that the object 301 is displayed across both the end part of the source touch-screen display and the end part of the target touch-screen display and that the ratio of that part of the object 301, which is displayed on the source touch-screen display, to the entirety of the object 301 may decrease to below the above-described predetermined threshold ratio. In this case, the object 301 is moved to the target touch-screen display so that the ratio between the part of the object 301, which is displayed on the source touch-screen display, and the part of the object 301, which is displayed on the target touch-screen display, may become a fixed ratio (e.g. 50:50).

A lowermost part of FIG. 7 shows a state in which the object 301, which has been moved onto the target touch-screen display, is touched by the fingertip once again, and the object 301 is dragged on the target touch-screen display.

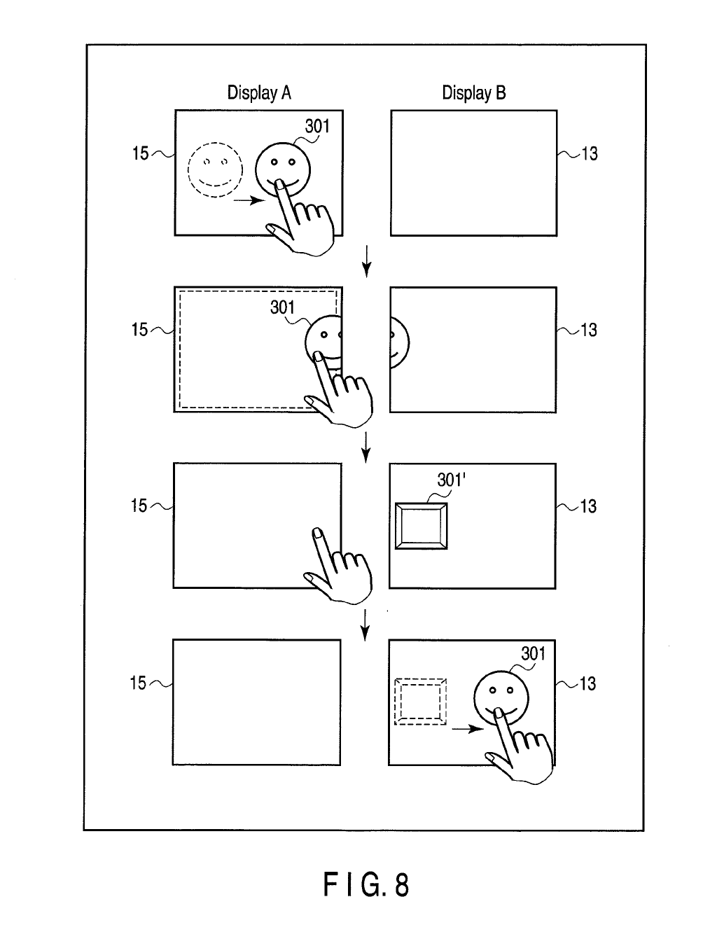

Next, referring to FIG. 8, still another example of the drag control operation, which is executed by the drag control program 201, is described. In FIG. 8, when the object 301 has been moved to the end part of the source touch-screen display by the movement of the user's fingertip, the drag control program 201 displays a substitute object 301′ on the region of the end part of the target touch-screen display.

An uppermost part of FIG. 8 shows a state in which the object 301, which is displayed on the source touch-screen display, is touched by the fingertip, and the object 301 is dragged.

A second part from above in FIG. 8 shows a state in which the object 301 has been moved to an end part of the source touch-screen display by a drag operation. For example, when the ratio of that part of the object 301, which is displayed on the source touch-screen display, to the entirety of the object 301 has decreased to a predetermined threshold ratio which is less than 100%, the drag control program 201 determines that the object 301 has been moved to the end part of the source touch-screen display.

When the object 301 has been moved to the end part of the source touch-screen display, the drag control program 201, as shown in a third part from above in FIG. 8, moves the position of the object 301 to the region of the end part of the target touch-screen display, and displays the substitute object 301′, in place of the object 301, on the region of the end part on the target touch-screen display. The display of the substitute object 301′ is useful in making the user aware that the drag operation is being executed. The substitute object 301′ may be of any shape.

If the substitute object 301′ on the target touch-screen display is touched by the fingertip or pen, the drag control program 201 displays the original object 301 in place of the substitute object 301′, as shown in a lowermost part of FIG. 8. This object 301 is moved in accordance with the movement of the touch position on the target touch-screen display.

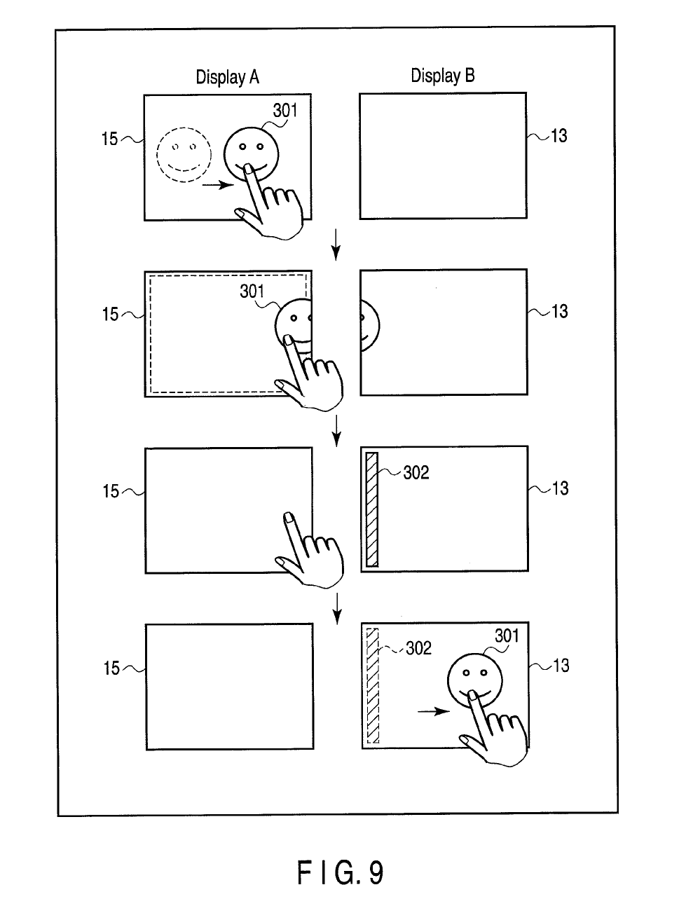

FIG. 9 shows an example in which a bar 302 is displayed as the substitute object 301′ shown in FIG. 8 on the region of the end part of the target touch-screen display.

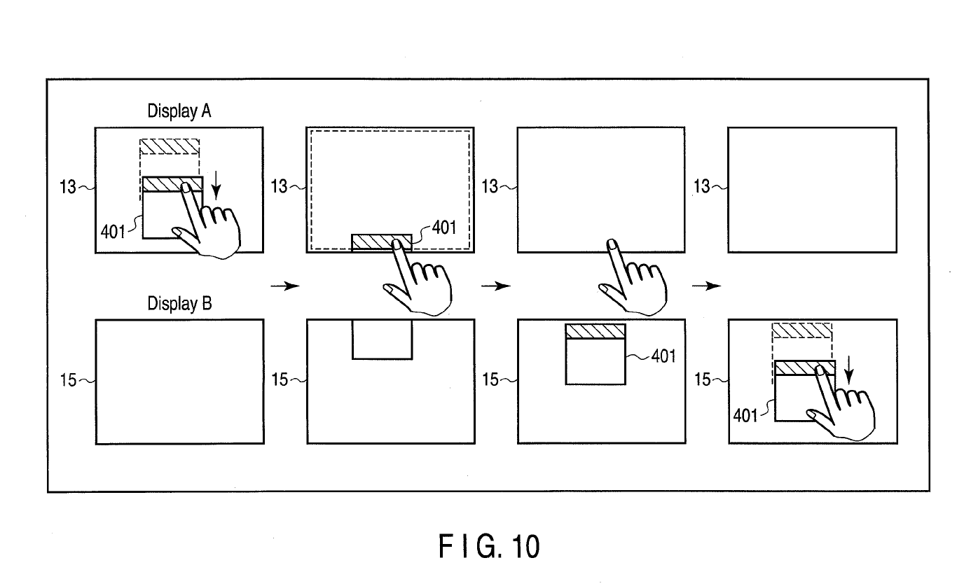

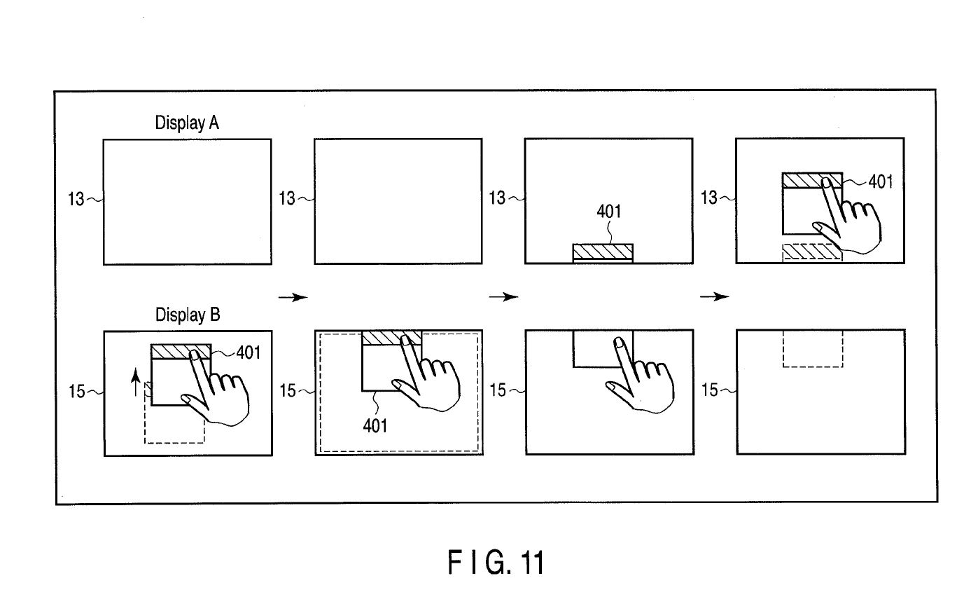

Next, referring to FIG. 10 and FIG. 11, a description is given of still other examples of the drag control operation which is executed by the drag control program 201. In FIG. 10 and FIG. 11, the case is assumed in which an object which is to be dragged is a window. In usual cases, a region (drag operation region), which can be designated to execute a drag operation of a window, is limited to a bar (title bar) which is provided at an upper part of the window. It is thus difficult for the user to drag the window by a touch operation from one to the other of two touch-screen displays which are arranged in the up-and-down direction.

FIG. 10 illustrates a drag control operation for dragging a window 401 from an upper-side source touch-screen display to a lower-side target touch-screen display, in the state in which the computer 10 is used in the horizontal position (landscape mode) described with reference to FIG. 2. The case is assumed in which the touch-screen display 13 is a source touch-screen display (display A) and the touch-screen display 15 is a target touch-screen display (display B).

A leftmost part in FIG. 10 illustrates a state in which the title bar of the window 401, which is displayed on the source touch-screen display, is touched by the fingertip, and the window 401 is dragged. In the state in which the user's fingertip is put in contact with the source touch-screen display, the user moves the fingertip, i.e. the touch position, whereby the user can move the position of the window 401.

A second part from the left in FIG. 10 illustrates a state in which the title bar of the window 401 has been moved to the lower end part of the source touch-screen display by the drag operation. When the title bar has been moved to the lower end part of the source touch-screen display, the drag control program 201, as shown in a third part from the left in FIG. 10, moves the position of the window 401 from the lower end part on the source touch-screen display to an upper end part of the target touch-screen display, so that, for example, almost the entirety of the window 401 may be displayed on the upper end part of the target touch-screen display. Thereby, for example, almost the entirety of the window 401 is displayed on the target touch-screen display.

A rightmost part of FIG. 10 illustrates a state in which the window 401, which has been moved onto the target touch-screen display, is touched by the fingertip once again, and the window 401 is dragged on the target touch-screen display. In the state in which the user puts the fingertip in contact with the target touch-screen display, the user moves the fingertip, that is, the touch position. Thereby, the position of the window 401 can be moved (dragged).

FIG. 11 illustrates a drag control operation for dragging the window 401 from the lower-side source touch-screen display (display B) to the upper-side target touch-screen display (display A), in the state in which the computer 10 is used in the horizontal position (landscape mode) described with reference to FIG. 2. The case is assumed in which the touch-screen display 15 is a source touch-screen display (display B) and the touch-screen display 13 is a target touch-screen display (display A).

A leftmost part of FIG. 11 illustrates a state in which the title bar of the window 401, which is displayed on the source touch-screen display, is touched by the fingertip, and the window 401 is dragged. In the state in which the user's fingertip is put in contact with the source touch-screen display, the user moves the fingertip, i.e. the touch position, whereby the user can move the position of the window 401.

A second part from the left in FIG. 11 illustrates a state in which the title bar of the window 401 has been moved to the upper end part of the source touch-screen display by the drag operation. When the title bar has been moved to the upper end part of the source touch-screen display, the drag control program 201, as shown in a third part from the left in FIG. 11, moves the position of the window 401 from the upper end part on the source touch-screen display to the lower end part of the target touch-screen display, so that at least the entire title bar of the window 401 may be displayed on the lower end part of the target touch-screen display.

A rightmost part of FIG. 11 illustrates a state in which the title bar, which has been moved onto the target touch-screen display, is touched by the fingertip once again, and the window 401 is dragged on the target touch-screen display. In the state in which the user puts the fingertip in contact with the target touch-screen display, the user moves the fingertip, that is, the touch position. Thereby, the position of the window 401 can be moved (dragged).

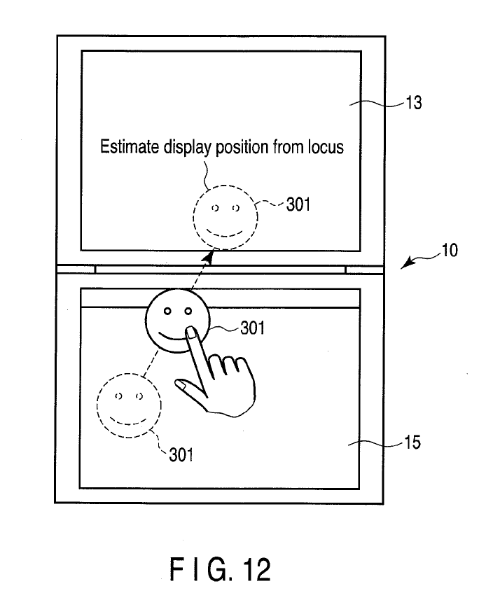

Next, referring to FIG. 12, still another example of the drag control operation, which is executed by the drag control program 201, is described. Based on the locus of movement of the object 301 on the source touch-screen display, the drag control program 201 estimates the position of the object 301 which is to be displayed on the target touch-screen display. For example, as shown in FIG. 12, the object 301 is moved in an upper-right direction by a drag operation on the lower-side source touch-screen display. When the object 301 is moved to an upper end part of the source touch-screen display, the drag control program 201 determines a position on the target touch-screen display, which is present in an upper-right direction from the position of the object 301 at the upper end part of the source touch-screen display, to be the display position of the object 301. The drag control program 201 displays the object 301 at the determined display position on the target touch-screen display.

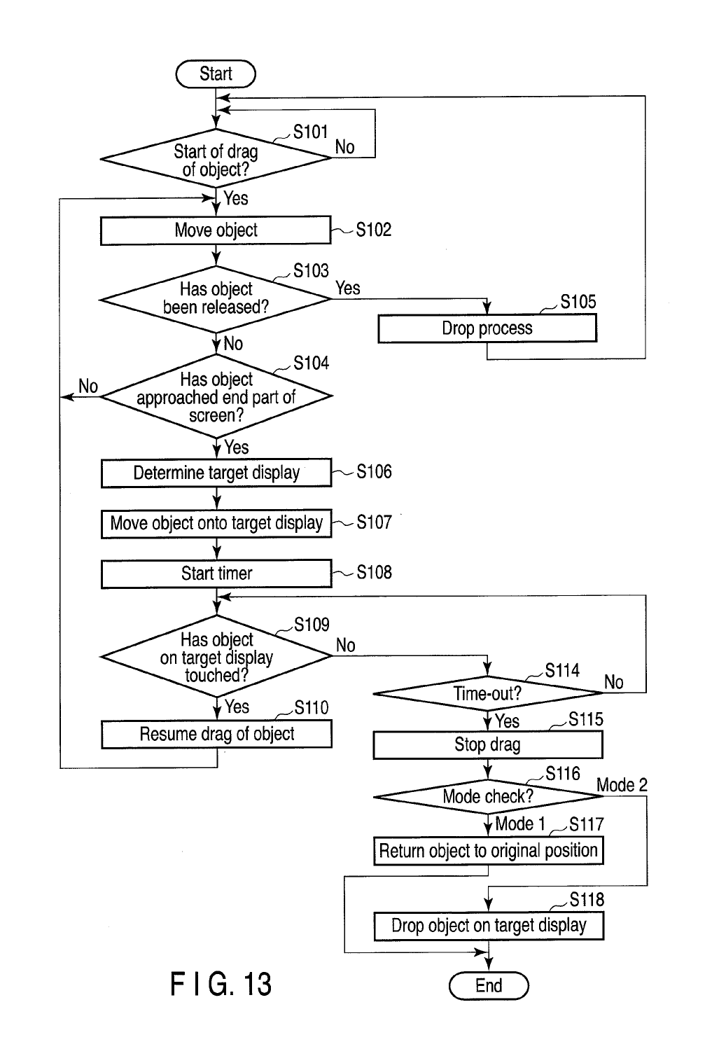

Next, referring to FIG. 13, a description is given of a drag control process which is executed by the drag control program 201.

To start with, the drag control program 201 determines whether a drag of an object on a touch-screen display (source touch-screen display) of a plurality of touch-screen displays in the computer 10 has been started (step S101). If the drag of the object is started, that is, if a position (touch position) of the user's fingertip or pen has been moved from a certain position on the source touch-screen display to another position in the state in which the object is selected by the user's fingertip or pen (YES in step S101), the drag control program 201 moves the position of the object on the source touch-screen display in accordance with the movement of the touch position (step S102).

In other words, in steps S101 and S102, the drag control program 201 selects the object on the source touch-screen display in accordance with the touch position on the source touch-screen display, and moves the selected object from a certain position on the source touch-screen display to another position in accordance with the movement of the touch position on the source touch-screen display.

If the selected object has been released, that is, if the fingertip or pen has gone out of contact with the source touch screen display (YES in step S103), the drag control program 201 drops the selected object at the present position and executes a predetermined process (action) associated with the drop position (step S105). For example, the selected object may be an icon representing a file. If this icon has been dropped on another icon representing a folder, the file is stored in the folder.

While the select object is being dragged, the drag control program 201 determines whether the selected object has approached an end of the source touch-screen display (step S104). When the selected object has approached the end of the source touch-screen object, that is, when the selected object has been moved to the end part on the source touch-screen display by the drag, the drag control program 201 determines a target touch-screen display from among the plural touch-screen displays (step S106). In step S106, the drag control program 201 determines a touch-screen display opposed via a display boundary (a non-touch-detection region including the hinge 14) to the end part, to which the selected object has been moved, to be the target touch-screen display.

In order to display the selected object on the target touch-screen display, the drag control program 201 moves the position of the selected object from the end part on the source touch-screen display to the end part of the target touch-screen display (step S107). In step 107, the drag control program 201 moves (shifts), for example, the position of the selected object (e.g. the position on the virtual screen) to the target touch-screen display by, e.g. a predetermined value (predetermined distance). Further, the drag control program 201 may move the object onto the target touch-screen display, while keeping the object in the selected state.

Subsequently, the drag control program 201 starts a timer and counts an elapsed time from a time point when the selected object was moved to the target touch-screen display (step S108).

If the object, which was moved onto the target touch-screen display, has been touched by the fingertip or pen before the counted elapsed time exceeds a threshold time (YES in step S109), the drag control program 201 resumes the drag of the object (step S110). The drag control program 201 moves the selected object from a certain position on the target touch-screen display to another position in accordance with the movement of the touch position on the target touch-screen display (step S102). If the selected object has been released, that is, if the fingertip or pen has gone out of contact with the target touch screen display (YES in step S103), the drag control program 201 drops the selected object at the present position and executes a predetermined process (action) associated with the drop position (step S105). If the selected object has been moved to an end part on the target touch-screen display by the drag (YES in step S104), the drag control program 201 executes a process of moving the selected object back to the end part on the source touch-screen display (step S106, S107).

On the other hand, if the object, which was moved onto the target touch-screen display, has not been touched before the counted elapsed time exceeds the threshold time, that is, if time-out occurs (YES in step S114), the drag control program 201 stops the drag control process (step S115). Then, the drag control program 201 determines whether the operation mode at the time of time-out is the above-described mode 1 or more 2 (step S116). If the operation mode of the time-out is mode 1, the drag control program 201 moves the position of the object back to the end part of the source touch-screen display, and displays the object on the end part of the source touch-screen display (step S117). If the operation mode of the time-out is mode 2, the drag control program 201 leaves the object on the end part on the target touch-screen display (step S118).

As has been described above, according to the present embodiment, when the object on the first touch-screen display has been moved to the end part on the first touch-screen display, which is opposed to the display boundary with the second touch-screen display, by the drag using the touch operation, the position of the object is moved from the first touch-screen display to the second touch-screen display. Thus, simply by dragging the object to the end part of the first touch-screen display by the touch operation, the user can move the object onto the second touch-screen display. Therefore, the operability of the drag operation of the object across the touch-screen displays can be enhanced.

The computer 10 of the embodiment includes the main body 11 and the display unit 12. It is not necessary to provide almost all the components, which constitute the system of the computer 10, within the main body 11. For example, some or almost all these components may be provided within the display unit 12. In this sense, it can be said that the main body 11 and the display unit 11 are substantially equivalent units. Therefore, the main body 11 can be thought to be the display unit, and the display unit 12 can be thought to be the main body.

Besides, the drag control function of the embodiment is realized by a computer program. Thus, the same advantageous effects as with the present embodiment can easily be obtained simply by installing the computer program into a computer including a plurality of touch-screen displays through a computer-readable storage medium which stores the computer program.

The various modules of the systems described herein can be implemented as software applications, hardware and/or software modules, or components on one or more computers, such as servers. While the various modules are illustrated separately, they may share some or all of the same underlying logic or code.

All of the processes described above may be embodied in, and fully automated via, software code modules executed by one or more general purpose or special purpose computers or processors. The code modules may be stored on any type of computer-readable medium or other computer storage device or collection of storage devices. Some or all of the methods may alternatively be embodied in specialized computer hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first touch-screen display;
a second touch-screen display;
a first movement control module configured to select and move a position of an object on the first touch-screen display in accordance with a touch-screen operation on the first touch-screen display; and
a second movement control module configured to move the position of the selected object from the first touch-screen display to the second touch-screen display in order to display the selected object on the second touch-screen display if the selected object is moved to an end part on the first touch-screen display, the end part comprising a boundary between the first touch-screen display and the second touch-screen display.

2. The information processing apparatus of claim 1, wherein the second movement control module is configured to move the position of the selected object toward the second touch-screen display by a predetermined distance.

3. The information processing apparatus of claim 1, wherein the second movement control module is configured to move the position of the selected object from the first touch-screen display to the second touch-screen display so that the selected object is fully displayed on the second touch-screen display.

4. The information processing apparatus of claim 1, wherein the second movement control module is configured to move the position of the selected object from the end part of the first touch-screen display to an end part of the second touch-screen display opposed to the boundary.

5. A drag control method for dragging an object between a first touch-screen display and a second touch-screen display in an information processing apparatus, the method comprising:
selecting an object on the first touch-screen display in accordance with a touch position on the first touch-screen display;
moving a position of the selected object in accordance with a movement of the touch position on the first touch-screen display; and
moving the position of the selected object to an end part on the first touch-screen display comprising a boundary between the first touch-screen display and the second touch-screen display,
wherein the selected object is moved from the first touch-screen display to the second touch-screen display in order to display the selected object on the second touch-screen display.

6. The drag control method of claim 5, wherein moving the position of the selected object to an end part on the first touch-screen display comprises moving the position of the selected object toward the second touch-screen display by a predetermined distance.

7. A computer readable non-transitory storage medium having stored thereon a program for dragging an object between a first touch-screen display and a second touch-screen display in an information processing apparatus, the program being configured to cause the information processing apparatus to:
select an object on the first touch-screen display in accordance with a touch position on the first touch-screen display;
move a position of the selected object in accordance with a movement of the touch position on the first touch-screen display; and
move the position of the selected object from the first touch-screen display to the second touch-screen display in order to display the selected object on the second touch-screen display when the selected object is moved to an end part on the first touch-screen display, the end part on the first touch-screen display being opposed to a boundary between the first touch-screen display and the second touch-screen display.

8. The computer readable medium of claim 7, wherein said causing the computer to move the position of the selected object from the first touch-screen display to the second touch-screen display comprises causing the computer to move the position of the selected object toward the second touch-screen display by a predetermined distance.
